(19) United States
(12) Patent Application Publication
(10) Pub. No.: US 2004/0114556 A1
(43) Pub. Date: Jun. 17, 2004

(54) Orthogonal code division multiple access on a return link

(76) Inventors: David S. Miller, Auckland (NZ); Leonard Norman Schiff, San Diego, CA (US)

Correspondence Address: Qualcomm Incorporated, Patents Department, 5775 Morehouse Drive, San Diego, CA, 92121-1714, US

(21) Appl. No.: 10/603,421

(22) Filed: Jun. 24, 2003

Related U.S. Application Data
(60) Provisional application No. 60/391,437, filed on Jun. 24, 2002.
(60) Provisional application No. 60/391,438, filed on Jun. 24, 2002.

(51) Int. Cl. H04B 7/216

(52) U.S. Cl. 370/335; 370/503

(57) ABSTRACT

A technique for realizing code synchronism to enable the application of modulation codes needed for implementing orthogonal CDMA modulation for reverse link communications. In a satellite communications system using orthogonal CDMA in the reverse link, a ground station transmits a first pilot signal in the forward link direction, which is acquired and tracked by a terminal or remote station, and used in recovering carrier phase and modulation chip clock timing. The terminal then derives a transmission carrier frequency and chip clock timing to be used, from the recovered forward pilot carrier frequency and chip clock timing. The terminal transmits a second pilot signal in the reverse link direction which, after being received and retransmitted by a satellite, is detected at the ground station. Terminals have the ability to advance or retard the timing of their signals for transmission relative to the timing derived from the forward link pilot signal. The ground station tracks timing, and in some embodiments also tracks frequency, of the terminal pilot signal, and compares these parameters to a reverse link reference signal. Based at least in part on the results of the comparison, the ground station transmits a control signal on the forward link to each terminal, thereby commanding the terminal to advance or retard its respective transmission timing. Each terminal then adjusts its transmission timing and/or frequency in small increments to maintain a desired level of time alignment with the ground station.

### RELATED APPLICATIONS

This application claims the benefit of prior filed provisional application 60/391,437, filed on Jun. 24, 2002, and 60/391,438, filed on Jun. 24, 2002.

### BACKGROUND OF THE INVENTION

1. Field of the Invention

The present invention relates generally to wireless communication systems, and more particularly to methods and apparatus for using orthogonal Code Division Multiple Access (O-CDMA) techniques in the return path of a communications system. In further aspects, the invention relates to providing code synchronization and employing O-CDMA by access terminals on return links in satellite communication systems.

2. Related Art

Various satellite communication systems have been developed over the years. One early system architecture uses an air interface or signal modulation technique referred to as Time Division Multiple Access (TDMA). TDMA is characterized by assignment of time slots in a communication channel to each of a plurality of user or remote terminals, and by having communication with each of the terminals take place in specifically assigned time slots. An improved system architecture uses an air interface or signal modulation technique referred to as Code Division Multiple Access (CDMA), which is characterized by the use of spread spectrum modulation techniques to provide separate user or user traffic signal channels. Such techniques are disclosed in the teachings of U.S. Pat. No. 4,901,307, which issued Feb. 13, 1990 under the title “Spread Spectrum Multiple Access Communication System Using Satellite or Terrestrial Repeaters,” and U.S. Pat. No. 5,103,459, issued Apr. 7, 1992, entitled “System And Method for Generating Signal Waveforms In A CDMA Cellular Telephone System,” which are both assigned to the assignee of the present invention and incorporated herein by reference.

CDMA based communication systems generally provide greater bandwidth efficiency than do TDMA based communication systems. Many CDMA based satellite communication systems typically operate in a CDMA mode over the forward link (FL) direction, that is, for signals transferred from hubs or gateways to the terminals, and in a TDMA mode over the return or reverse link (RL) direction, that is, for signals transferred from terminals to the gateway.

There are two main types or modes of CDMA communication signal processing in use, asynchronous CDMA and synchronous orthogonal CDMA. In the asynchronous mode of CDMA operation, the signals from different terminals are not synchronized and, as such, can arrive out of code phase or sync and cause interference to each other. In the synchronous mode of operation, the signals transmitted from different terminals are timed so as to arrive synchronously, and are in code phase with each other or have code synchronization, at the receiver. In the synchronous mode of CDMA, if orthogonal codes are used to distinguish different terminal transmissions, then there is generally no, or very little, cross-interference among the different signals received from terminals, due to a cross-correlation approaching zero. This technique and resulting waveforms are referred to as Orthogonal CDMA (O-CDMA). In this case, one achieves higher bandwidth efficiency due to reduced interference.

On the forward link, orthogonality among different codes is effectively maintained because all signals originate at the same location, namely at the hub or gateway providing communication service to one or more remote terminals. Where several gateways are used throughout a communication system, they are generally configured to use a common timing source, such as the phase of signals detected from GPS satellites, which employ a form of what is referred to as Universal Time. Alternatively, or in addition, gateways can be in communication with each other and/or a timing signal reference, in order to provide a synchronization mechanism. Other such mechanisms are known in the art or being contemplated.

However, for signals being transferred by terminals on the return link, there is generally no common synchronization mechanism, and signals transmitted from different terminals arrive asynchronously at the gateway(s) due to the their different propagation delays or paths, even if the timing of the initial transmission is close to synchronization, which it often may not be. Therefore, while satellite communication systems can easily incorporate orthogonal CDMA for use on forward links, they cannot make use of this technique on the reverse links. In order to improve communication, through reducing potential interference and other deleterious effects, what is needed are methods and apparatus for enabling orthogonal CDMA to be employed in the return signal paths of a satellite communication system, or over the reverse communication links.

### SUMMARY OF THE INVENTION

Briefly, code synchronism or synchronization is achieved thereby enabling the use of modulation codes desired to implement orthogonal CDMA in the return direction. In a satellite communications system including a geostationary satellite, the use of orthogonal CDMA in the reverse link is advantageously enabled by embodiments of the present invention. A ground station transmits a first or forward link pilot signal in the forward link direction, and one or more terminals acquire and track the pilot signal, recovering carrier phase and timing for the modulation code (chip) clock timing used by the communication system. A terminal then derives a transmit or transmission carrier frequency to be used for signals it transmits, and code chip clock timing to be used for signal modulation, from the recovered forward pilot carrier frequency and chip clock timing. The terminal transmits a second or reverse link pilot signal in the reverse link direction which, after being received and retransmitted by the satellite, is detected at the ground station. The ground station tracks timing, and in some embodiments also tracks frequency, of the terminal originated pilot signal and compares these characteristics to those of a reverse link reference signal. Terminals, in accordance with the present invention, have the ability to advance or retard the timing of their transmitted signals relative to the timing derived from the forward link pilot signal, and they do so based, at least in part, on the results of the timing comparison with the reference. This is accomplished by having the ground station transmit a control signal on the forward link to each terminal it desires to communication with in a beam or sub-beam, providing commands or instructions to each terminal as to a desired amount or degree by which it should advance or retard the respective transmit timing for achieving desired synchronization of the reverse link signals. Each terminal then adjusts its transmit timing and/or frequency in small increments to maintain time alignment with the ground station.

A method of providing orthogonal CDMA communication in a return link, in accordance with the present invention includes, receiving a first pilot signal at a plurality of terminals; deriving at least one transmit timing characteristic from the received first pilot signal, wherein deriving is performed within each of the plurality of terminals; transmitting, at an assigned time a pilot signal from each of the plurality of terminals in accordance with the derived at least one transmit timing characteristic; receiving a control signal, the content of the control providing instructions to adjust the at least one transmit timing characteristic; and adjusting, responsive to the control signal, the least one transmit timing characteristic.

A method of operating a communications system including a geosynchronous satellite disposed in a forward link and a reverse link, to provide orthogonal CDMA communication in the reverse link, in accordance with the present invention includes, transmitting a first pilot signal from a ground station in the forward link direction; receiving the first pilot signal at a terminal, and recovering carrier phase and modulation chip clock timing therein; deriving a transmit carrier frequency and chip clock timing from the recovered forward pilot carrier frequency and modulation chip clock timing; transmitting a second pilot signal from the terminal in the reverse link direction; comparing, at the ground station, the second pilot signal to a reverse link reference signal; transmitting, in the forward link direction, a control signal, the content of the control signal based at least in part on the comparison between the second pilot signal and the reverse link reference signal; and adjusting, responsive to the control signal, at least one operational parameter of the terminal.

Such a method may further include transmitting orthogonal CDMA traffic signals from the terminal.

In some embodiments of such a method, the at least one operational parameter of the terminal comprises transmit timing; and adjusting is performed to maintain the transmit timing of the terminal to within a predetermined fraction of a code chip period, for example within ⅛ of a chip period.

Such a method may further include providing a reverse uplink receiver beam width of approximately 0.5°.

In some embodiments of such a method, the control signal directs the terminal to advance its transmit timing, while in others it directs the terminal to retard its transmit timing. The timing in embodiments may be advanced or retarded by predetermined amounts, or by an amount specified by the control signal.

An embodiment of a terminal, includes, means for receiving a first pilot signal; means for recovering carrier phase and modulation chip clock timing from the first pilot signal; means for transmitting a second pilot signal; means for receiving a control signal; means for transmitting an orthogonal CDMA traffic signal to a geostationary satellite, the orthogonal CDMA traffic signal having a first timing characteristic; and means for adjusting the first timing characteristic.

In some embodiments of such a terminal, the means for adjusting the first timing characteristic comprises circuitry for advancing a transmit timing characteristic of the orthogonal CDMA traffic signal by a predetermined amount, and in others means for retarding a transmit timing characteristic of the orthogonal CDMA traffic signal by a predetermined amount.

In some embodiments of such a terminal the means for adjusting the first timing characteristic comprises circuitry for advancing, and others for retarding, a transmit timing characteristic of the orthogonal CDMA traffic signal by an amount specified by the control signal.

### BRIEF DESCRIPTION OF THE DRAWINGS

The features, objects, and advantages of the present invention will become more apparent from the detailed description set forth below when taken in conjunction with the drawings in which like reference characters identify the same or similar elements throughout and wherein:

FIG. 1 illustrates one embodiment of the present invention in a satellite system.

FIG. 2 is a block diagram representation of a receiver for receiving a plurality of concurrent CDMA transmissions on the return link from a corresponding plurality of terminals.

FIG. 3 is a block diagram representation of a transmitter in a terminal adapted to send messages on the return link of an OCDMA satellite communications system.

FIG. 4 is a flowchart of an illustrative process that shows operations of a gateway.

FIG. 5 is a flowchart of an illustrative process using a terminal.

FIG. 6 illustrates one embodiment of a hardware system to implement various embodiments.

FIG. 7 illustrates one embodiment of a machine-readable medium to store executable instructions to implement various embodiments.

### DETAILED DESCRIPTION

Generally, embodiments of the present invention provide improved bandwidth efficiencies, increased ability to overcome rain fade or other channel degrading phenomenon, reduced transmission power, or various combinations thereof. More particularly, by advantageous use of orthogonal CDMA in the return link of a geosynchronous satellite based communication system, embodiments of the present invention permit a plurality of access terminals, each with a unique code channel assignment, to transmit concurrently in a beam, with the same or lower aggregate power as would be used by a single access terminal using TDMA as its access method. In other embodiments, advantageous use of orthogonal CDMA in the return link allows one or more access terminals, each in a common beam and assigned a common time slot, to transmit at a higher transmission power to overcome channel degradation effects such as those due to rain fade.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention.

Various aspects of the invention may be implemented as circuit-based solutions, including possible implementation on a single integrated circuit. As would be apparent to one skilled in the art, various functions of circuit elements may also be implemented as processing operations in a software program. Such software may be employed in, for example, a digital signal processor, micro-controller, embedded controller, or general-purpose computer. It is well known that most gateways use arrays or racks of circuit cards and assemblies to accomplish all of the signal processing tasks they undertake. These cards may have specialized controllers and processors, or use commercially available computer processor chips and various types of memory to perform certain functions. In addition, entire computers, workstations, and other similar devices are often integrated into the system designs, and are used to operate and control certain functions in a gateway or a base station.

Many wireless devices such as telephones, PDAs, and modems, also contain sophisticated signal processing elements, resources, and capabilities to accommodate the features expected in modern device designs.

The invention can be embodied in the form of methods as well as apparatus for practicing those methods. The present invention can also be embodied in the form of program code embodied in tangible media, such as punched cards, magnetic tape, floppy disks, hard disk drives, CD-ROMs, flash memory cards, or other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a processor, the machine becomes an apparatus for practicing the invention. When implemented on a programmable controller, signal processor, general-purpose processor and the like, the program code segments combine with the processor to provide a unique device that operates analogously to specific logic circuits.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

Terminology

A “chip”, as used herein, refers to a binary state or value which is used to produce a “code.” That is a series of binary values referred to as code “chips” are used to generate a particular code or code sequence. While a chip can be referring to a binary state in a spread spectrum signal or Pseudorandom (PN) code, as used herein they are generally referring to orthogonal channelizing codes or code sequences used to establish different communication channels for user terminals within beams or sub-beams. Typically, these are well known Walsh codes, used to create orthogonal communication channels in a communication system.

The terms, base station, and gateway, are sometimes used interchangeably in the art, with gateways being perceived as specialized base stations that direct communications through satellites, while base stations use terrestrial antennas to direct communications within a surrounding geographical region. The expression ground station is sometimes used interchangeably in this field with gateway.

Communications satellites may form beams which illuminate a “spot” or area produced by projecting satellite communications signals onto the Earth's surface. A typical satellite beam pattern for a spot comprises a number of beams arranged in a predetermined coverage pattern. Typically, each beam comprises a number of so-called sub-beams covering a common geographic area, each occupying a different frequency band. In appropriate instances, the sub-beams may be referred to as CDMA or FDM channels.

The expressions reverse link, reverse direction, return link, and return direction, are sometimes used interchangeably in this field. Unless specified otherwise in the context of their usage herein, these expressions, and formulations similar thereto, refer to communication pathways by which signals propagate from a terminal unit to a satellite, and from the satellite to a ground station. In terrestrial communication systems, they propagate from a terminal to a base station directly.

The expressions forward link and forward direction are sometimes used interchangeably in this field. Unless specified otherwise in the context of their usage herein, these expressions, and formulations similar thereto, refer to communication pathways by which signals propagate from a ground station to a satellite, and from the satellite to a terminal unit. In terrestrial communication systems, they propagate from a base station to a terminal directly.

The expression up-link refers to pathways by which signals propagate either from a ground station to a satellite or from a terminal to a satellite. The expressions forward up-link and forward down-link refer to pathways by which signals propagate from a ground station to a satellite and from a satellite to a terminal, respectively; while the expressions reverse up-link and reverse down-link refer to pathways by which signals propagate from a terminal to a satellite and from a satellite to a ground station, respectively.

Terminals, or user terminals, are also sometimes referred to as access terminals, subscriber units, mobile units, mobile stations, or simply “users,” “mobiles,” or “subscribers” in some communication systems, depending on preference. These terms are well understood in this field.

Conventional satellite-based communication systems are known which use orthogonal CDMA in the forward link direction, and which do not use orthogonal CDMA in the reverse link direction. Systems which do not use orthogonal CDMA in the reverse link may also be referred to as having an interference shared reverse channel.

Typical Wireless Communications System Environment

An exemplary wireless communication system in which various embodiments of the invention find application may include as parts of that communication system, at least one geo-stationary communication satellite and at least one ground station, which are suitable for effecting communications with one or more remote user terminals. Although the invention is described primarily in terms of wireless, satellite-based communications, the present invention may be applicable to other types of communications channel(s), including digital, electrical or optical, wireless or wire/fiber, etc.

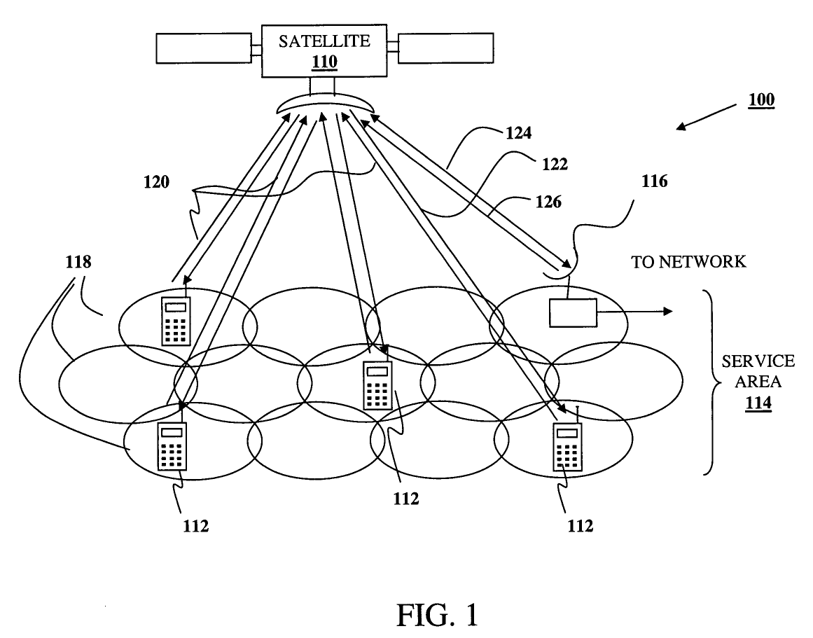

FIG. 1 illustrates a satellite-based communications system 100 incorporating one or more satellites 110 that relay communications between a plurality or series of user terminals (112a, 112b, 112c, 112d) in a service area 114 and at least one gateway 116, there sometimes being more than one in a service area. Gateway 116 could provide, for instance, an access point between the satellite network and external networks, such as the Internet or some other external network (partially shown). The terminals communicate with the external network through the satellite 110 and the gateway 116.

Service area 114 is covered by one or more beams, or cells, such-as beam 112, which are projected onto the surface of the Earth by satellite 110. Beams illuminate a “spot” or area produced by projecting satellite communications signals onto the Earth's surface. The beams are arranged in a predetermined coverage pattern. Each beam generally uses either the full frequency spectrum available to the satellite in the case of a full frequency reuse pattern, or some division of the available frequency spectrum in the case of a partial reuse pattern. Each beam may also include a number of so-called sub-beams (also referred to as FDM signals, channels, or links) covering a common geographic area, with each sub-beam occupying a particular frequency band.

The group of signals that go from the terminals through satellite 110, down to gateway 116 comprise the “return link.” The return link includes a number of uplinks 120 from the terminals, and a downlink 124 from satellite 110 to gateway 116. The return uplinks 120 are generally all combined at satellite 110 into the return downlink 124, although this is not necessarily required. In one embodiment, code divisional multiple access (CDMA) is used in the return link to distinguish among signals from various terminals. That is, multiple terminals can simultaneously transmit in a shared frequency band using separate codes.

For completeness, FIG. 1 also shows the group of signals that go from the gateway 116 through satellite 110, down to terminals 112 (112a, 112b, 112c, 112d) which comprise the “forward link.” The forward link includes a number of downlinks 122 to the terminals, and an uplink 126 from satellite 110 to gateway 116.

The user terminals (112a, 112b, 112c, 112d) are each wireless communication devices such as, but not limited to, a cellular telephone, a data transceiver, or a two-way pager, and each can be hand-held or vehicle-mounted as desired. It is also understood that the teachings of the invention are applicable to fixed units where remote wireless service is desired, including “indoor” as well as “open air” locations.

CDMA spread-spectrum communications systems typically contemplate the use of coherent modulation and demodulation for forward link user terminal communications. In communication systems using this approach, a “pilot” carrier signal, also referred to as a “pilot signal,” is used as a coherent phase reference for forward link signals. That is, a signal which contains no data modulation is transmitted by a ground station (i.e., a gateway or a base station) throughout a region of coverage as a reference.

Pilot signals are used by user terminals to obtain initial system synchronization and provide time, frequency, and phase tracking of other signals transmitted by the gateway or base station. Phase information obtained from tracking a pilot signal carrier is used as a carrier phase reference for coherent demodulation of other system signals or traffic (i.e., data) signals. This technique allows many traffic signals to share a common pilot signal as a phase reference, providing for a less costly and more efficient tracking mechanism. A single pilot signal is typically transmitted by each gateway or base station for each frequency used, referred to as a CDMA or FDM channel or sub-beam, and shared by all user terminals receiving signals from that gateway or base station on that frequency.

In order to implement orthogonal CDMA in the return direction of a satellite based communications system, embodiments include the use of orthogonal codes as part of the signal modulation, and demodulation. These codes comprise a series of binary values referred to as code “chips”, and are generally based on well known Walsh codes. The communication system employs a known code-phase relationship between signals from at least two terminals in a beam. The known code-phase relationship between signals for the various user terminals is such that the timing or phase of the respective Walsh codes are separated relative to each other by only a small fraction of a chip period or duration, and maintain carrier frequency differences that are generally within a few degrees of each other.

Methods and apparatus in implanted in accordance with the invention provide for synchronizing the return up-link transmissions of a set of terminals in a beam of a geostationary satellite network with a precision at least adequate to allow the use of orthogonal CDMA techniques.

In an illustrative embodiment, which includes a geo-stationary satellite as part of the communication system, a ground station transmits a first or forward link pilot signal in the forward link direction. One or more user terminals located in the forward link beam acquire and track the transmitted pilot signal. Each terminal operates so as to recover carrier phase and modulation chip clock timing from the pilot signal that originated at the ground station. The terminal then derives its transmit or transmission carrier frequency and chip clock timing from the recovered forward pilot carrier frequency and modulation chip clock timing. Such a method avoids the need for expensive stabilized reference oscillators in the user terminals. A similar method can be employed in terrestrial cellular CDMA subscriber terminals.

In addition to timing synchronization (i.e., code phase synchronization), the frequency offset between the transmitter of the access terminal and the receiver of the gateway should also be made small enough so that the phase change of the signal over the period of one orthogonal code is negligible, as discussed below. In one method for achieving frequency synchronization between an access terminal and the gateway, the access terminal adjusts the frequency of its oscillator so as to lock to the frequency of the signal received from the gateway.

At a time appropriate for the particular access protocol in use (which is well understood in the art), each terminal in communication with the ground station transmits a second or reverse link pilot signal in the reverse link direction, that is subsequently detected at a receiver in the ground station. at a receiver in the ground station after being relayed through a satellite. The user terminals, in accordance with the invention, have the ability to advance or retard the timing of transmissions or transmitted signals relative to the timing previously derived from the forward link pilot signal.

The terminals track timing characteristics for the ground station signals (first pilot), and subsequently the ground station tracks timing characteristics for terminals. Generally, this is in the form of monitoring an operational parameter, such as the signal timing, for the code phase synchronization. However, that is just one timing characteristic of a terminal, with another timing characteristic, as seen from above, that is optionally tracked, being the frequency of the either the first or second pilot signal(s) transmitted from the ground station or each user terminal. Typically, the offset value between the tracked frequency and a reference frequency is the operational parameter used.

The terminals derive at least one transmit timing characteristic from the received first pilot signal, with the derivation being performed within each of the plurality of terminals. The terminals then transmit, at an assigned time a pilot signal from each of the plurality of terminals in accordance with the derived at least one transmit timing characteristic.

A reverse link reference signal is generated, typically by the ground station itself. The ground station compares at least the timing of the terminal originated second pilot signals to that of the reverse link reference signal. A return link reference signal, generated at the ground station, represents the ideal timing, or nearly so, of a perfectly timed return link transmission as it should be received at the ground station. Such a reference signal can be derived from a local reference, delayed by the predicted round trip delay to and from a reference point on the earth (typically the center of the beam) through a satellite transponder, plus a suitable margin to allow for more distant terminals. Alternatively, this reference signal can be derived from the received pilot signals of one or more representative user terminals.

Based, at least in part, upon this comparison of the reference and reverse link pilot signal or signals, the ground station determines the nature of certain timing or control information which is to be transmitted to each terminal. The timing or control information represents such information or data that indicates the timing discrepancy between the reverse link pilot signals and the reference signal. This information is to be used by a user terminal to alter the timing of the transmitted signals it is providing to the ground station, generally by advancing or retarding signal timing, in order to achieve a desired timing for synchronization, relative to the reference signal.

The ground station then transmits a control, command, or reference signal on the forward link to each desired terminal, which acts to instruct the terminal to advance or retard its transmit timing, or alter its transmission frequency in some embodiments. This can be referred to as control signaling. In response to the information or commands provided by the ground station, each terminal then adjusts its transmit timing and/or frequency, typically, in small increments, in accordance with the instructions received, to maintain time alignment with the receiver(s) in the ground station. Such a process of determining and implementing the changes in a terminal's transmit timing, which are used to maintain the time alignment, may be performed for a plurality of terminals in a beam. Ensuring the desired time alignment is one aspect of the present invention which enables the use of orthogonal CDMA in the return direction.

Therefore, in the illustrative examples, a ground station transmits a forward link pilot signal. A user terminal acquires and tracks the forward link pilot signal, recovering the carrier phase and modulation chip clock timing. A user terminal derives its transmit carrier frequency and chip clock timing from the recovered forward pilot carrier frequency and chip clock timing. Such a method avoids the need for expensive stabilized reference oscillators in the user terminals. It is noted that a similar method is employed in terrestrial cellular CDMA subscriber terminals.

It is noted that the synchronization mechanism described above is designed to synchronize the signal arrivals at the Walsh code boundary, where those signals originate with different access terminals.

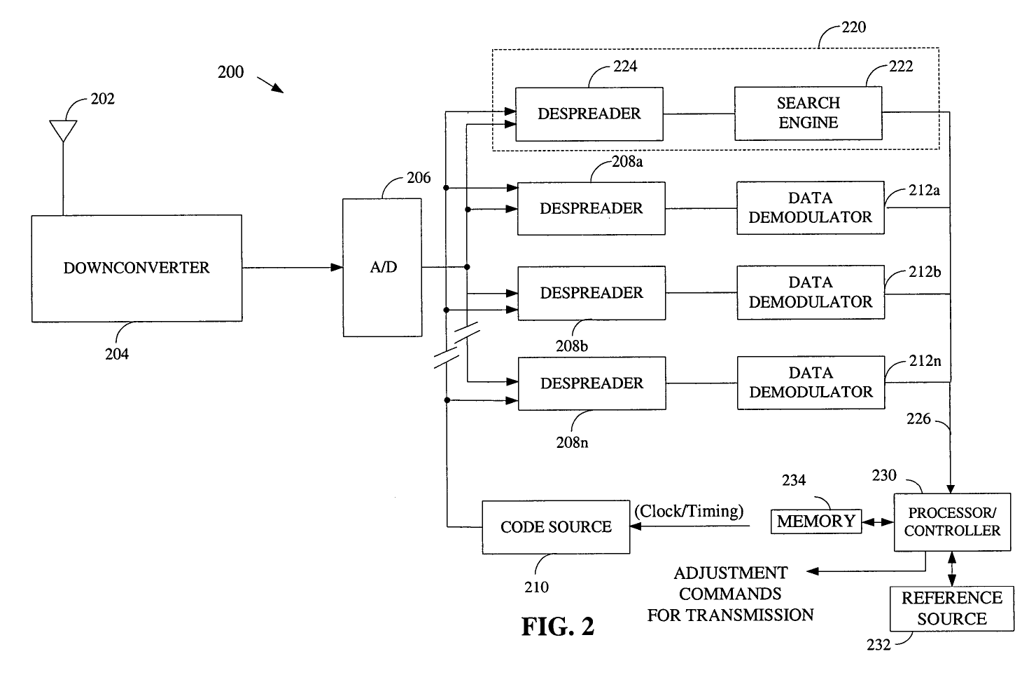

FIG. 2 is a block diagram representation of a receiver 200 for receiving a plurality of concurrent CDMA transmissions on the return link from a corresponding plurality of terminals. The receiver of FIG. 2 includes an antenna 202 coupled to a downconverter 204. The downconverter takes an RF signal and reduces the frequency. Various techniques for downconversion are known but are not described further herein. The output of the downconverter is coupled to an analog-to-digital (A/D) converter 206 which converts an analog signal to a corresponding signal in the digital domain. The output of A/D converter 206 is coupled to each of a plurality of despreaders 208a, 208b, 208n. There is no particular limit on the number of despreaders, although in some embodiments, the number of despreaders is equal to the number of code-modulated (i.e., CDMA) signals that a gateway may receive from access terminals in any particular time period or slot. A code source 210 is also coupled to each of despreaders 208a, 208b, 208n. Code source 210 provides the despreaders with the code needed to despread the incoming CDMA signals. The output terminal of each despreader 208a, 208b, 208n is coupled respectively to an input terminal and a data demodulator 212a, 212b, 212n.

This architecture is used because here because, in accordance with the present invention, a plurality of access terminals are transmitting OCDMA signals to the gateway in parallel.

In order to generate the desired commands or control signals discussed further below, receiver 200 uses the despreaders 208a, 208b, 208n and demodulators 212a, 212b, 212n, or one or more specialized searchers 220 which provide the despreading function 222 along with a search engine 224 for detecting the various, non-data bearing, pilot signals being received from the terminals. Information from the searcher 220 or the demodulators is received by a receiver controller or processor 230, from an input bus or line 226.

Processor 230 uses the information to determine certain operational parameters from, or associated with, the pilot signals from user terminals, such as either timing or frequency offsets. This is generally accomplished by detecting and comparing the timing or frequency with that of a reference signal. Here, the reference signal is shown being provided by a reference source 232 which provides an input to the processor. Reference source 232 could be configured to generate the reference at the time it is needed, such as using highly stable and accurate oscillators or timing circuits, or could store values previously generated by processor 230.

In addition, processor 230 can use various types of memory 234 to store information about what types of commands are desirable to issue depending on the results of the comparison. For example, if the comparison shows the timing is too fast or frequency is too high, the processor can simply send a command or request to retard either parameter in the terminal. If, on the other hand, the frequency is too low or the timing is too slow, the processor can send a simple command requesting the terminal to advance the value. However, the processor can also send more complicated instructions, as desired, in some systems in which it specifies the amount of the offsets to be compensated for and a request for adjustment, or a specific value by which an adjustment should be made. Such commands can be sent as separate signals or appended to other communications, such as traffic, access instructions, or command and control signals being forwarded to the terminals.

It is to be understood that typical receivers in ground stations and gateways are known to have one or more controllers for detecting certain characteristics of the signals being received, to affect timing changes for output signals, to assist with the timing and control of demodulation, code selection, and other processes within the ground station. Processor 230 can form part of such controllers or be configured as a separate processor which is dedicated to the operations of embodiments of the invention.

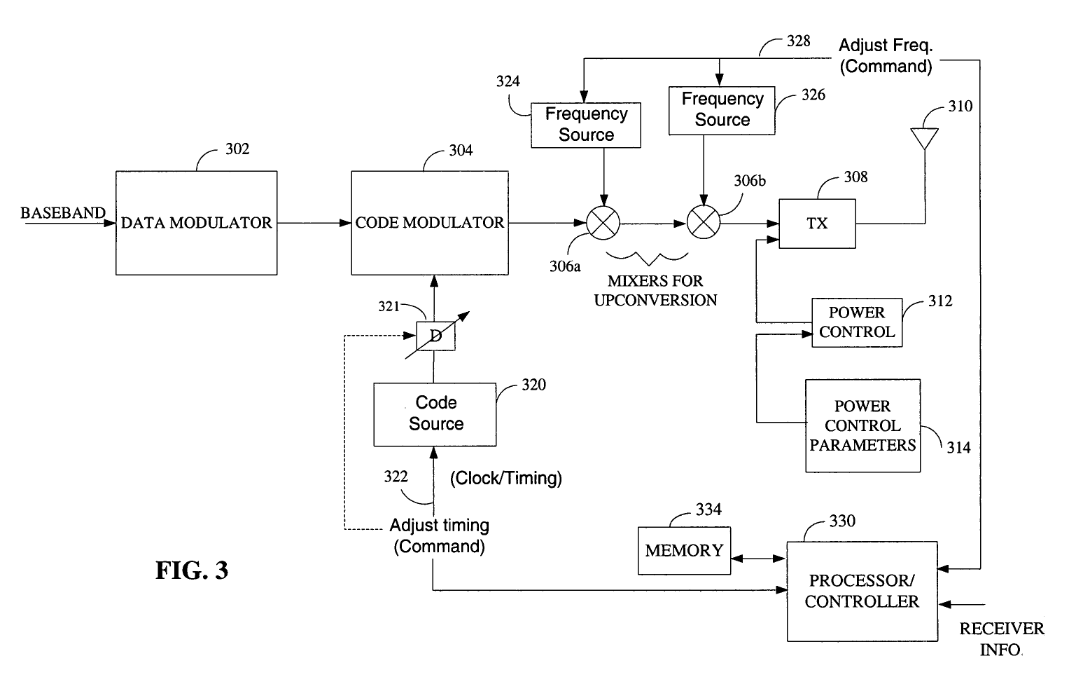

FIG. 3 is a block diagram representation of a transmitter 300 in a terminal adapted to send messages or data in the return link of an OCDMA satellite communications system. As sated above, in prior systems, access terminals received CDMA signals from the gateway, but used TDMA to communicate in or over a return link. The transmitter shown in FIG. 3 is adapted not only to transmit CDMA signals but also to adjust its transmit timing or code phase, as well as typically its power, as described in detail below. This transmitter includes a data modulator 302 that modulates the baseband signal and a code modulator 304 that further modulates, in accordance with the code channel assigned to this particular access terminal, the signal to be transmitted. The output of code modulator 304 is up-converted by a series of mixers 306a and 306b in this illustrative example. Any suitable means of up-conversion may be used. A final transmitter circuit 308 determines the transmit power in accordance with control signals received from a power control unit 312. Power control unit 312 is coupled to receive control information from the power control parameter storage unit 314. The transmitter power control is a function of the transmit power instruction received by the access terminal from the gateway, and of the access terminal's own determination of channel degradation effects. The terminal estimates signal strength changes on the FL, for instance due to fading caused by rain, by measuring the signal strength on the FL. Whenever there is a change in the signal strength on the FL, the terminal estimates the corresponding signal strength change on the RL and makes an adjustment to the data rate and/or the transmission power on the RL accordingly. In one embodiment, the terminal will use a calibration table to determine the RL signal strength changes based on the FL signal variation.

In order to utilize the desired commands or control signals discussed further below, terminal 300 uses the code modulator 304 and mixers 306 along with, a code source or controller 320, frequency sources 324 and 326, and information from a receiver portion of the terminal which is provided to a terminal controller or processor 330, from an input bus or line.

Processor 330 uses command or control information received by a receiver portion, which is well known in the art, and similar to that shown for the ground station, to determine what commands or requests for adjustment have been forwarded to the terminal, and what action is appropriate to take to adjust certain operational parameters associated generation and transmission of signals from the terminals. For example, processor 330 determines if either timing or frequency offsets are being compensated for and by what amount. The commands may specify and amount of adjustment or simply that a predetermined adjustment take place to either retard or advance the parameter values. In addition, processor 330 can use various types of memory 334 to store information about what types of actions are desirable to implement depending on the adjustment information or commands being received. For example, where fixed adjustment commands are sent, processor 330 can use previously stored information to select the amount by which a parameter is changed. The memory may indicate different amounts that can change with time, or other activities within the terminal, and so forth.

If an adjustment request is based on the timing being too fast or frequency too high, the processor commands either the code source 320, on line 322 to retard the code timing, or one or more of the frequency sources 324, 326 on line 328 to retard or decrease the frequency, respectively. If, on the other hand, the adjustment request is based on the timing being too slow, or the frequency too low, processor 330 commands either the code source 320 to advance the code timing, or one or more of the frequency sources 324, 326 to advance or increase the frequency, respectively. Alternatively, processor 330 can use one or more adjustable delay elements to adjust the code timing external of the code source, as desired.

It is to be understood that typical terminals are known to have one or more controllers for detecting certain characteristics of the signals being received or transmitted, to affect timing changes for output signals, to assist with the timing and control of modulation, code selection, and other processes within the terminal. Processor 330 can form part of such controllers or be configured as a separate processor which is dedicated to the operations of embodiments of the invention.

It is also noted that the retarding and advancement of code timing is discussed and illustrated in the patents referred to above as well as in U.S. Pat. No. 6,327,534B1, issued Dec. 4, 2001, which is incorporated herein by reference, and those skilled in the art will readily understand how to implement this process in a variety of ways.

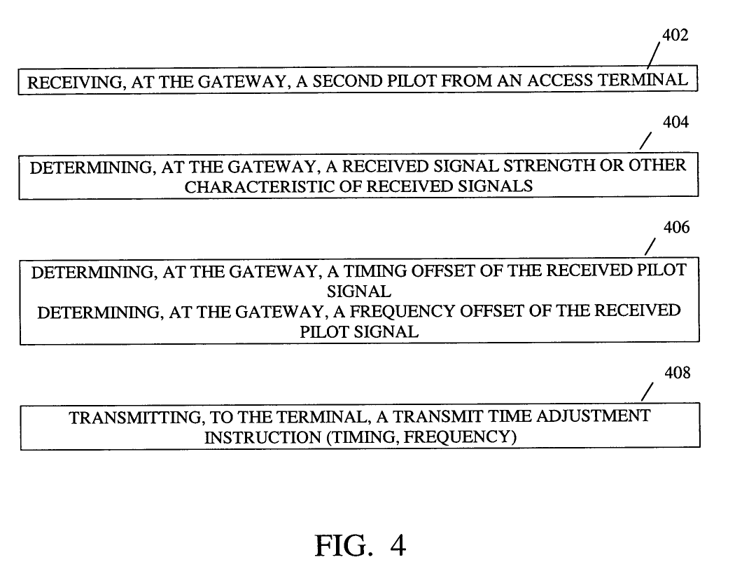

FIG. 4 is a flowchart of an illustrative process that shows operations of a gateway in accordance with an embodiment. This illustrative process includes receiving in step 402, at the gateway, a message, here a pilot signal, from a user terminal. This signal can be used for other activities or analysis such as determining the channel conditions between the gateway and the terminal in step 404, which does not form part of the invention. The terminal may use any suitable means of contacting the gateway for this initial message. The method further includes determining in step 406, at the gateway, a timing offset or timing affecting operational parameter of the received pilot signal. Determining this offset, whether something such as frequency or timing, is one aspect of establishing OCDMA in the return link. The illustrative method further includes transmitting in step 408, to the terminal, a transmit time adjustment instruction; along with typical transmit power instructions. In further aspects, the gateway may detect a frequency offset as an operational parameter for timing in a step 406, and then transmit a frequency adjustment instruction in step 408, as well. The time and frequency adjustment instructions enable the terminal to advance or retard transmission time and/or frequency in order to maintain a desired degree of code synchronism for OCDMA in the return link.

It is noted that the synchronization mechanism described above is designed to synchronize the signal arrivals at the Walsh code boundary, where those signals originate with different access terminals.

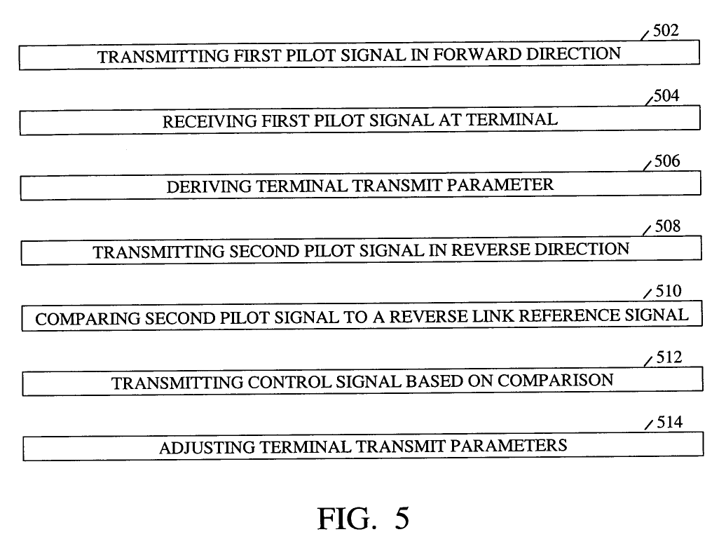

Referring to FIG. 5, a method of operating a communications system including a geo-synchronous satellite disposed in a forward link and a reverse link, to provide orthogonal CDMA communication in the reverse link, is illustrated. More particularly, a first pilot signal is transmitted in step 502 from a ground station in the forward link direction. That is, a signal is sent from gateway 116 to a satellite 110, which in this embodiment is in a geosynchronous orbit, and that signal is relayed to a portion of the Earth's surface. The first pilot signal is received in step 504 at a user terminal (112), and the terminal recovers carrier phase and modulation chip clock timing from the first pilot signal.

The terminal then derives a transmit carrier frequency and chip clock timing in step 506 from the recovered forward pilot carrier frequency and modulation chip clock timing. The terminal then transmits a second pilot signal in the reverse link direction in step 508 to the geosynchronous satellite (110) and the satellite relays the second pilot signal to the ground station (116). The second pilot signal is compared in step 510 at the ground station to a reverse link reference signal. The ground station then transmits in step 512, in the forward link direction (i.e., up to the satellite, and then from the satellite down to the terminal), a control signal, where the content of the control signal is based at least in part on the comparison between the second pilot signal and the reverse link reference signal. In response to the control signal, at least one operational parameter related to transmissions from the terminal, is adjusted in step 514 within the terminal. Typically, such adjustments relate to advancing or retarding the timing of the terminal's transmitted signals relative to the timing derived from the forward link pilot signal.

The timing can be advanced or retarded using several pre-selected approaches or techniques to determine the amount or magnitude by which an adjustment is made. In one embodiment, during system design a predetermined amount of adjustment or change in timing or frequency is selected and used as the basis for responding to control signals. Such values can be based on known empirical data as to how quickly or effectively a terminal adjusts parameters, and how large a change is generally required to achieve a given result. It can also be based on design characteristics of the terminal. In addition, there may be delay factors in executing the instructions which might lead one to want to make smaller changes within the terminal to avoid overshooting a desired value. There is no desire to make very large changes which result in further changes being requested in an opposite direction, and so forth. It is desirable to quickly but efficiently move toward a solution without incurring any substantial overshoots in the results which take more time to correct. In addition, the overall changes required may be rather small as a general rule depending on the known communication system characteristics, size of beams, terminal characteristics (frequency stability, timing), and so forth. It may also be more effective or desirable to have the terminal chose a predetermined amount so as to shorten the type of control signal information or commands that would be transmitted from the ground station.

However, in some configurations, it may be more desirable to have the ground station instruct the terminal with a more precise amount of adjustment desired to potentially reach a desired end result quicker, or if only one quick small change is needed, for example. In addition, it is often desirable to perform as much of the computational and information storage activities or functions within a ground station instead of a terminal which is more power and volume constrained for having storage or memory elements or more complicated controllers. Those skilled in the art will readily understand the characteristics of a given communication system that allow them to address this choice.

There is no desire to make very large changes which result in further changes in an opposite direction being needed, and so forth. It is desirable to quickly but efficiently move toward a solution without incurring large overshoots in the results. In addition, the overall changes required may be rather small as a general rule depending on the known communication system characteristics, size of beams, terminal characteristics (frequency stability, timing), and so forth. In addition, it may be more effective to have the terminal chose a predetermined amount to shorten the type of control signal information or commands that would be needed.

However, in some configurations, it may be more desirable to have the ground station instruct the terminal with a more precise amount of adjustment desired to potentially reach a desired end result quicker, or if only one quick small change is needed, for example. Those skilled in the art will readily understand the characteristics of a given communication system that allow them to address this choice.

The velocity of a typical geo-stationary satellite relative to a fixed earth terminal position has been estimated at between 0.3 m/s and 3 m/s, depending on the specific design and control parameters for various (known) geo-stationary satellites. At 3 m/s, the Doppler effect is about 10-8, with frequency Doppler being about 300 Hz and Code Doppler, that is, the delay rate, being about 10 ns/s. If the satellite return up link receiver beam width is about 0.5°, then the worst case difference in time rate between a terminal at the center of the beam and any other terminal served by the same beam is on the order of 10 ns/s times sin(0.25°)=0.044 ns/s.

For an exemplary code chip rate of around 3 Mcps, the period or time interval for one chip equals 333 ns, and a representative fractional period such as a ⅛ chip rate represents a period of approximately 42 ns. In this situation, the worst case drift in residual delay between two terminals in the same beam is ⅛ chip in 42/0.044=954 seconds, or about 16 minutes. However, other fractional periods can be used as a target value or could occur in a communication system depending on the specific known configurations of beams, locations of terminals, and communication link characteristics.

In view of the preceding, it can be seen that with just one correction every few minutes, the transmit timing of a terminal can be controlled to within one ⅛th of a chip period, which is sufficient to support orthogonal CDMA modes of transmission.

Between this transmit timing adjustment process and maintaining a very tight uplink beam width (e.g., 0.5 degrees or less) code synchronism is achieved, thereby enabling the use of the modulation codes needed for orthogonal CDMA in the return direction.

This is desirable as discussed earlier because a greater bandwidth efficiency may be obtained with the use of orthogonal CDMA as compared to TDMA. With respect to an OCDMA return link, L users are each assigned a unique orthogonal Walsh code. Each user sends one data modulation symbol during each Walsh code period or time interval. In other words, each access terminal repeats a data modulation symbol L times over the period of its assigned Walsh code resulting in a processing gain of L. Let (E_{b}/Nₜ)_{TDMA} denote the energy per bit measured in a TDMA based system for a given coding and modulation scheme. Then, if each access terminal in the OCDMA system, transmits at its maximum available power, the E_{b}/Nₜ received on the OCDMA channel for one access terminal on the return link, denoted by (E_{b}/Nₜ)_{OCDMA}, is given by:

(E_{b}/Nₜ)_{OCDMA}=L(E_{b}/Nₜ)_{TDMA}

In other words, for the same transmit power at the access terminal, the achievable E_{b}/Nₜ is L times greater on the OCDMA channel than on the TDMA channel due to the processing gain of OCDMA. Therefore, one may use a higher order modulation in the case of OCDMA and achieve higher bandwidth efficiency than in the TDMA approach. Note that in OCDMA each access terminal effectively has 1/Lth of the bandwidth that one access terminal in the TDMA system has. That is, the data rate on one OCDMA channel is, for the same modulation/coding choice, L times lower than on the TDMA channel. However, it can be seen that since, for the same transmit power a higher order modulation/coding scheme may be used for an OCDMA access terminal, the bandwidth efficiency of OCDMA is greater.

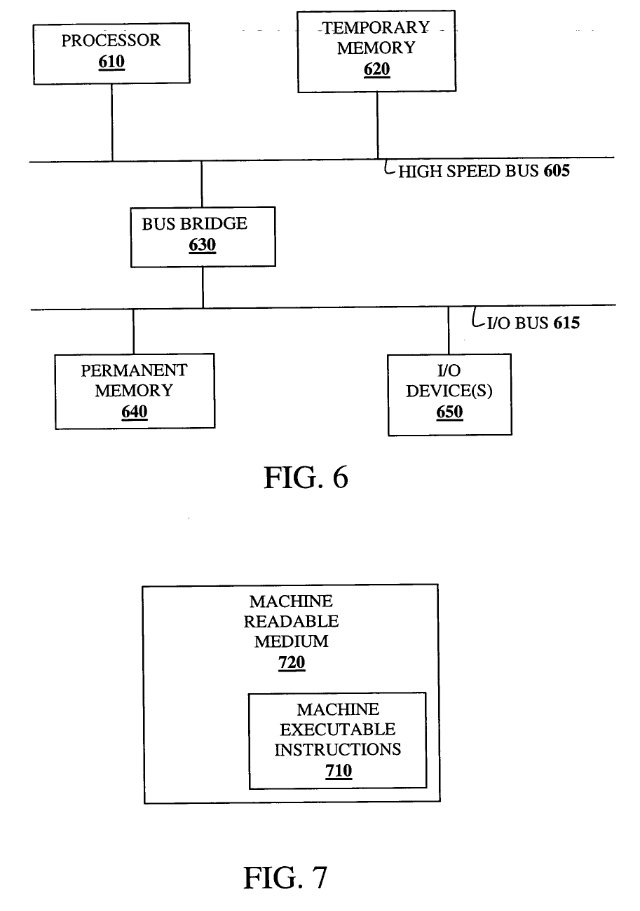

Various embodiments of the present invention require computational resources to carryout the above-described functionality. FIG. 6 illustrates one embodiment of a hardware system intended to represent a broad category of computer systems such as personal computers, workstations, and/or embedded systems. In the illustrated embodiment, the hardware system includes processor 610 coupled to high speed bus 605, which is coupled to input/output (I/O) bus 615 through bus bridge 630. Temporary memory 620 is coupled to bus 605. Permanent memory 640 is coupled to bus 615. I/O device(s) 650 is also coupled to bus 615. I/O device(s) 650 may include a display device, a keyboard, one or more external network interfaces, etc.

Certain embodiments may include additional components, may not require all of the above components, or may combine one or more components. For instance, temporary memory 620 may be on-chip with processor 610. Alternatively, permanent memory 640 may be eliminated and temporary memory 620 may be replaced with an electrically erasable programmable read only memory (EEPROM), wherein software routines are executed in place from the EEPROM. Some implementations may employ a single bus, to which all of the components are coupled, or one or more additional buses and bus bridges to which various additional components can be coupled. Those skilled in the art will be familiar with a variety of alternative internal networks including, for instance, an internal network based on a high speed system bus with a memory controller hub and an I/O controller hub. Additional components may include additional processors, a CD ROM drive, additional memories, and other peripheral components known in the art.

In one embodiment, the present invention, as described above, is implemented using one or more hardware systems such as the hardware system of FIG. 6. Where more than one computer is used, the systems can be coupled to communicate over an external network, such as a local area network (LAN), an internet protocol (IP) network, etc. In one embodiment, the present invention is implemented as software routines executed by one or more execution units within the computer(s). For a given computer, the software routines can be stored on a storage device, such as permanent memory 640.

Alternately, as shown in FIG. 7, the software routines can be machine executable instructions 710 stored using any machine readable storage medium 720, such as a diskette, CD-ROM, magnetic tape, digital video or versatile disk (DVD), laser disk, ROM, Flash memory, etc. The series of instructions need not be stored locally, and could be received from a remote storage device, such as a server on a network, a CD ROM device, a floppy disk, etc., through, for instance, I/O device(s) 650 of FIG. 6.

From whatever source, the instructions may be copied from the storage device into temporary memory 620 and then accessed and executed by processor 610. In one implementation, these software routines are written in the C programming language. It is to be appreciated, however, that these routines may be implemented in any of a wide variety of programming languages.

In alternative embodiments, discrete hardware or firmware may be used. For example, one or more application specific integrated circuits (ASICs) could be programmed with one or more of the above described functions of the present invention. In another example, one or more functions of the present invention could be implemented in one or more ASICs on additional circuit boards and the circuit boards could be inserted into the computer(s) described above. In another example, field programmable gate arrays (FPGAs) or static programmable gate arrays (SPGA) could be used to implement one or more functions of the present invention. In yet another example, a combination of hardware and software could be used to implement one or more functions of the present invention.

### CONCLUSION

Methods and apparatus in accordance with embodiments of the invention utilize orthogonal CDMA in the return link of satellite communication systems to advantageously provide greater transmit power margins to compensate for channel degradation effects, such as rain fade.

It is to be understood that the present invention is not limited to the embodiments described above, but encompasses any and all embodiments within the scope of the subjoined claims.

What we claim as our invention is:

1. A method of providing orthogonal CDMA communication in a return link, comprising:
receiving a first pilot signal at a plurality of terminals;
deriving at least one transmit timing characteristic from the received first pilot signal, wherein deriving is performed within each of the plurality of terminals;
transmitting, at an assigned time, a pilot signal from each of the plurality of terminals in accordance with the derived at least one transmit timing characteristic;
receiving a control signal, the content of the control signal providing instructions to adjust the at least one transmit timing characteristic; and
adjusting, responsive to the control signal, the at least one transmit timing characteristic.

2. The method of claim 1, further comprising providing a reverse uplink receiver beam width of approximately 0.5°.

3. A method of operating a communications system having a forward link and a reverse link, to provide orthogonal CDMA communication in the reverse link, comprising:
transmitting a first pilot signal from a ground station in the forward link direction;
receiving the first pilot signal at a terminal, and recovering carrier phase and modulation chip clock timing therein;
transmitting a second pilot signal from the terminal in the reverse link direction;
comparing, at the ground station, the second pilot signal to a reverse link reference signal;
transmitting, in the forward link direction, a control signal, the content of the control signal based at least in part on the comparison between the second pilot signal and the reverse link reference signal; and
adjusting, responsive to the control signal, at least one operational parameter of the terminal.

4. The method of claim 3, further comprising transferring signals through a geosynchronous satellite disposed in said forward link and reverse link.

5. The method of claim 3, further comprising transmitting orthogonal CDMA traffic signals from the terminal.

6. The method of claim 3, wherein the at least one operational parameter of the terminal comprises transmit timing; and adjusting is performed to maintain the transmit timing of the terminal to within a pre-selected fractional part of a chip period.

7. The method of claim 6, wherein the pre-selected fractional part is one-eighth of a chip period, or less.

8. The method of claim 6, further comprising providing a reverse uplink receiver beam width of approximately 0.5°.

9. The method claim 3, wherein the control signal directs the terminal to advance its transmit timing.

10. The method of claim 9, wherein the transmit timing is advanced by a predetermined amount.

11. The method of claim 9, wherein responsive to the control signal, the terminal transmit timing is adjusted by an amount specified by the control signal.

12. The method of claim 3, wherein the control signal directs the terminal to retard its transmit timing.

13. The method of claim 12, wherein the transmit timing is retarded by a predetermined amount.

14. The method of claim 12, wherein responsive to the control signal, the terminal transmit timing is adjusted by an amount specified by the control signal.

15. The method claim 3, wherein the control signal directs the terminal to adjust its transmission frequency.

16. A terminal, comprising:
means for receiving a first pilot signal;
means for recovering carrier phase and modulation chip clock timing from the first pilot signal;
means for transmitting a second pilot signal from the terminal;
means for receiving a control signal;
means for transmitting an orthogonal CDMA traffic signal, the orthogonal CDMA traffic signal having a first timing characteristic; and
means for adjusting the first timing characteristic in response to said control signal.

17. The terminal of claim 16, wherein the means for transmitting an orthogonal CDMA traffic signal comprises a geostationary satellite.

18. The terminal of claim 16, wherein the at least one operational parameter of the terminal comprises transmit timing; and said means for adjusting maintains the transmit timing of the terminal to within a pre-selected fractional part of a chip period.

19. The terminal of claim 18, wherein the pre-selected fractional part is one-eighth of a chip period, or less.

20. The terminal of claim 16, further comprising means for providing a reverse uplink receiver beam width of approximately 0.5°.

21. The terminal of claim 16, wherein the means for adjusting the first timing characteristic comprises circuitry for advancing a transmit timing characteristic of the orthogonal CDMA traffic signal.

22. The terminal of claim 16, wherein the means for adjusting the first timing directs the terminal to advance its transmit timing.

23. The terminal of claim 22, wherein the transmit timing is advanced by a predetermined amount.

24. The terminal of claim 22, wherein the means for adjusting the first timing characteristic comprises circuitry for advancing a transmit timing characteristic of the orthogonal CDMA traffic signal by an amount specified by the control signal.

25. The terminal of claim 16 wherein the means for adjusting the first timing characteristic comprises circuitry for retarding a transmit timing characteristic of the orthogonal CDMA traffic signal.

26. The terminal of claim 25 wherein the means for adjusting the first timing characteristic comprises circuitry for retarding a transmit timing characteristic of the orthogonal CDMA traffic signal by a predetermined amount.

27. The terminal of claim 25, wherein the means for adjusting the first timing characteristic comprises circuitry for retarding a transmit timing characteristic of the orthogonal CDMA traffic signal by an amount specified by the control signal

28. The terminal of claim 25 wherein the circuitry for retarding a transmit timing characteristic of the orthogonal CDMA traffic signal comprises a clock output connected to a code modulator, and a control input connected to a signal receiver.

29. A ground station operating in a communications system having a forward link and a reverse link, to provide orthogonal CDMA communication in the reverse link, comprising:
means for transmitting a first pilot signal in the forward link direction;
means for receiving a second pilot signal from at least one terminal in the reverse link direction, and for recovering carrier phase and modulation chip clock timing therein;
means for comparing the second pilot signal to a reverse link reference signal; and
means for transmitting, in the forward link direction, a control signal to control at least one operational parameter of the terminal, the content being based at least in part on the comparison between the second pilot signal and the reverse link reference signal.

30. A terminal device, comprising:
a processor;
a memory of stored CDMA signal transmit timing characteristic control information coupled to the processor; and
a machine accessible medium, coupled to the processor, having instructions encoded therein, the instructions, when executed by the processor, cause the terminal device to:
receive a first pilot signal;
recover carrier phase and modulation chip clock timing from the first pilot signal;
transmit a second pilot signal;
receive a control signal;
transmit an orthogonal CDMA traffic signal having a first timing characteristic; and
adjusting the first timing characteristic in response to said control signal.

31. The terminal device of claim 30, wherein the instructions, when executed by the processor further cause the terminal device to provide a reverse uplink receiver beam width of approximately 0.5°.

32. The terminal device of claim 30, wherein the instructions, when executed by the processor further cause the terminal device to advance a transmit timing characteristic of the orthogonal CDMA traffic signal.

33. The terminal device of claim 30, wherein the instructions, when executed by the processor further cause the terminal device to retard a transmit timing characteristic of the orthogonal CDMA traffic signal.

34. The terminal device of claim 30, wherein memory is part of the terminal device.

35. The terminal device of claim 30, wherein the instructions, when executed by the processor further cause the terminal device to adjust a transmit frequency of the orthogonal CDMA traffic signal by an amount specified by the control signal.
